(19) United States
(12) Patent Application Publication
(10) Pub. No.: US 2025/0003819 A1
(43) Pub. Date: Jan. 2, 2025

(54) ULTRA-COMPACT STACKED DIFFERENTIAL PRESSURE SENSOR

(71) Applicant: STMicroelectronics International N.V., Geneva (CH)

(72) Inventors: Massimiliano Pesaturo, Torre de' Roveri (IT); Marco Omar Ghidoni, Melzo (IT); Mikel Azpeitia Urquia, Milano (IT)

(21) Appl. No.: 18/214,892

(22) Filed: Jun. 27, 2023

(51) Int. Cl. G01L 9/00; G01L 19/14

(52) U.S. Cl. CPC G01L 9/0048; G01L 19/147; G01L 19/148; G01L 19/149

(57) ABSTRACT

An ultra-compact stacked differential pressure sensor is provided, which includes a differential pressure sensor stacked on an ASIC stacked on a substrate. The differential pressure sensor is connected to the ASIC by an inner ring and outer ring. The region between the inner ring and outer ring forms an isolation region. The ASIC may be connected to the substrate with glue. Each of the ASIC and substrate may have a through hole channel and the differential pressure sensor may have a back channel. The differential pressure sensor is exposed to a first pressure on a first side and a second pressure via the differential pressure back channel, the ASIC channel, and the substrate channel. The differential pressure sensor may generate an electrical signal based on a difference in pressures between the first environment and the second environment.

### TECHNOLOGICAL FIELD

Example embodiments of the present disclosure relate generally to differential pressure sensors, particularly to ultra-compact stacked differential pressure sensors.

### BACKGROUND

Differential pressure sensors allow for the generation of an electrical signal reflecting a measurement of a difference in pressure between a first environment and a second environment. Devices incorporating differential pressure sensors are continuing to be reduced in size, which requires the differential pressure sensors to also be reduced in size.

New differential pressure sensors are needed. The inventors have identified numerous areas of improvement in the existing technologies and processes, which are the subjects of embodiments described herein. Through applied effort, ingenuity, and innovation, many deficiencies, challenges, and problems have been solved by developing solutions that are included in embodiments of the present disclosure, some examples of which are described in detail herein.

### BRIEF SUMMARY

Various embodiments described herein relate to differential pressure sensors, particularly ultra-compact stacked differential pressure sensors. Various embodiments described herein also relate to systems, apparatuses, and methods for the differential pressure sensors described here.

In accordance with some embodiments of the present disclosure, an example apparatus is provided. The apparatus may comprise: a differential pressure sensor with a first side of the differential pressure sensor, a second side of the differential pressure sensor, and a differential pressure sensor channel, wherein the differential pressure sensor channel includes an aperture on the second side; an ASIC with an ASIC channel, wherein the ASIC channel that connects a first side of the ASIC with the second side of the ASIC; a substrate with a first side of the substrate, a second side of the substrate, and a substrate channel that connects the first side of the substrate with the second side of the substrate; wherein the differential pressure sensor is connected to the ASIC by a first inner ring and a second outer ring, wherein the first inner ring surrounds the second outer ring to form an isolation region between the first inner ring and the second outer ring; and wherein the ASIC is connected to the substrate by a first glue.

In some embodiments, the differential pressure sensor includes a sensing membrane to sense a pressure difference between a first pressure on a first side of the differential pressure sensor and a second pressure from a second side of the differential pressure sensor.

In some embodiments, the second pressure is transmitted to the sensing membrane via the differential pressure sensor channel, the ASIC channel, and the substrate channel.

In some embodiments, the isolation region is at least partially filled with a second glue.

In some embodiments, the apparatus further comprises a structure attached to the substrate, wherein the differential pressure sensor and the ASIC are encompassed by the structure.

In some embodiments, the structure is at least partially filled with a gel to cover the differential pressure sensor and the ASIC.

In some embodiments, the differential pressure sensor channel, the ASIC channel, and the substrate channel are aligned with a common axis.

In accordance with some embodiments of the present disclosure, an example method is provided. The example method may be a method of manufacturing an ultra-compact differential pressure sensor comprising: creating a substrate channel in a substrate; creating a ASIC channel in an ASIC; attaching the ASIC to the substrate with a first glue; applying a first ring and a second ring to the ASIC forming an isolation region between the first ring and the second ring; attaching the differential pressure sensor to the ASIC with the first ring and the second ring.

In some embodiments, the differential pressure sensor includes a sensing membrane to sense a pressure difference between a first pressure on a first side of the differential pressure sensor and a second pressure from a second side of the differential pressure sensor.

In some embodiments, the second pressure is transmitted to the sensing membrane via a differential pressure sensor channel, the ASIC channel, and the substrate channel.

In some embodiments, the method further comprises filling, prior to attaching the differential pressure sensor to the ASIC with the first ring and the second ring, the isolation region with a second glue.

In some embodiments, the method further comprises attaching a structure to the substrate to encompass the differential pressure sensor and the ASIC.

In some embodiments, the method further comprises filling the structure at least partially with a potting gel, wherein the potting gel covers the differential pressure sensor and the ASIC.

In some embodiments, the differential pressure sensor channel, the ASIC channel, and a substrate channel are aligned with a common axis.

In accordance with some embodiments of the present disclosure, a second example method is provided. The second example method may be a method of using an ultra-compact differential pressure sensor comprising: providing an ultra-compact differential pressure sensor comprising: a differential pressure sensor with a first side of the differential pressure sensor, a second side of the differential pressure sensor, and a differential pressure sensor channel, wherein the differential pressure sensor channel includes an aperture on the second side; an ASIC with an ASIC channel, wherein the ASIC channel that connects a first side of the ASIC with the second side of the ASIC; a substrate with a first side of the substrate, a second side of the substrate, and a substrate channel that connects the first side of the substrate with the second side of the substrate; wherein the differential pressure sensor is connected to the ASIC by a first inner ring and a second outer ring, wherein the first inner ring surrounds the second outer ring to form an isolation region between the first inner ring and the second outer ring; wherein the ASIC is connected to the substrate by a first glue; sensing a difference between a first pressure and a second pressure with a sensing membrane of the differential pressure sensor; and generating an electrical signal based on the difference between the first pressure and the second pressure sensed.

In some embodiments, the method further comprises transmitting, prior to sensing the difference between the first pressure and the second pressure, the second pressure to the sensing membrane via the differential pressure sensor channel, the ASIC channel, and the substrate channel.

In some embodiments, the isolation region is at least partially filled with a second glue.

In some embodiments, the ultra-compact differential pressure sensor further comprises: a structure attached to the substrate, wherein the differential pressure sensor and the ASIC are encompassed by the structure.

In some embodiments, the structure is at least partially filled with a gel to cover the differential pressure sensor and the ASIC.

In some embodiments, the differential pressure sensor channel, the ASIC channel, and the substrate channel are aligned with a common axis.

The above summary is provided merely for the purpose of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF SUMMARY OF THE DRAWINGS

Having thus described certain example embodiments of the present disclosure in general terms, reference will now be made to the accompanying drawings, which are not necessarily drawn to scale, and wherein:

FIG. 1 illustrates a cross-section view of an example block diagram of an ultra-compact differential pressure sensor in accordance with one or more embodiments of the present disclosure;

FIG. 2 illustrates a top down view of an example block diagram of a first portion of an ultra-compact differential pressure sensor in accordance with one or more embodiments of the present disclosure;

FIG. 3 illustrates a top down view of an example block diagram of a second portion of an ultra-compact differential pressure sensor in accordance with one or more embodiments of the present disclosure;

FIG. 4 illustrates a cross-section view an example block diagram of an ultra-compact differential pressure sensor including a structure in accordance with one or more embodiments of the present disclosure;

FIG. 5 illustrates an example block diagram of a first flow chart of operations for manufacturing an exemplary ultra-compact differential pressure sensor in accordance with one or more embodiments of the present disclosure; and

FIG. 6A-6G illustrate example diagrams for operations to prepare a channel in an ASIC; and

FIG. 7 illustrates an example block diagram of a flow chart of operations for operating an exemplary ultra-compact differential pressure sensor in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

### Overview

Various embodiments of the present disclosure are directed to an ultra-compact stacked differential pressure sensor, including systems, apparatuses, and methods for manufacturing and utilizing an ultra-compact differential pressure sensor. The ultra-compact differential pressure sensor is ultra-compact with its stacked design that stacks a differential pressure sensor with an ASIC and substrate. The differential pressure sensor is exposed to a first environment with a first pressure on a first side (e.g., a top side), and it is exposed to a second environment with a second pressure on a second side (e.g., bottom side) via channels or through holes in the differential pressure sensor, ASIC, and substrate. A sensor membrane measures a difference between the first pressure and the second pressure and generates an electrical signal with a transducer based on the measurement.

The ultra-compact stacked differential pressure sensor may be utilized in applications requiring differential pressure measurements but only have a small amount of space. Such applications include, among other things, environmental sensors, MEMS sensors, medical sensors, and industrial sensors that require a compact sized systems, apparatuses, and/or devices. As applications require smaller sized devices, differential pressure sensors have had to be miniaturized. This has led to many applications requiring two separate pressure sensors instead of one differential pressure sensor, including due to how to expose a differential pressure sensor to multiple pressures. Additionally, the smaller devices may be required to operate in harsh environments where protective layers may increase the size of the differential pressure sensor.

The ultra-compact differential pressure sensor described herein addresses such issues by, among other things, stacking a differential pressure sensor and an ASIC on a substrate. A top side of the differential pressure sensor may expose a sensing membrane to a first pressure of a first environment. Channels through the back side of the differential pressure sensor and channel through the ASIC and substrate subject the sensing membrane to a second pressure of a second environment. The difference in the first and second pressures applied to the sensing membrane is used in generating a differential pressure measurement signal. The differential pressure sensor, ASIC, and substrate may be electrically coupled through a plurality of bonding wires. These bonding wires may be used to transmit signals between, from, and/or to the differential pressure sensor, ASIC, and/or substrate. For example, the differential pressure measurement signal generated may be based on one or more signals transmitted from the differential pressure sensor to the ASIC that then generates an electrical signal of the differential pressure measurement signal. The ASIC may then transmit this electrical signal to the substrate where it is subsequently transmitted from the substrate to one or more circuitries of a system and/or device. For example, there may be one or more terminals on the bottom of the substrate that may be used to electrically couple the ultra-compact differential pressure sensor with circuitry of a system and/or device.

The stacked differential pressure sensor, ASIC, and substrate may utilize a plurality of film rings to create an isolation region between the differential pressure sensor and the ASIC. The plurality of film rings creates an isolation region between the rings that provide for improved isolation between the environments. The plurality of rings and isolation region also provide improved isolation of the differential pressure sensor from thermal and mechanical stresses the ASIC that would otherwise transmit to the differential pressure sensor. Those stresses would impact measurements made by the sensing element. The isolation from the stresses also increases the longevity of the ultra-compact differential pressure sensor.

In various embodiments, the stacked differential pressure sensor, ASIC, and substrate may utilize a B-stage glue layer between the ASIC and the substrate. The B-stage glue may additionally provide improvements in manufacturing as the two stages of the B-stage glue may allow for the deposition of the B-stage glue into a desired pattern that holds its shape during manufacturing between the dispensing of the glue and the attachment of the ASIC. Various embodiments may also use a B-stage glue to attach the differential pressure sensor to the ASIC, including by using the B-stage glue deposited in one or more patterns. Such patterns may be based on the thermos-mechanical stresses the ultra-compact differential pressure sensor may experience.

### Exemplary Systems and Apparatuses

Embodiments of the present disclosure herein include systems and apparatuses for an ultra-compact stacked differential pressure sensor that may be implemented in various embodiments as described herein.

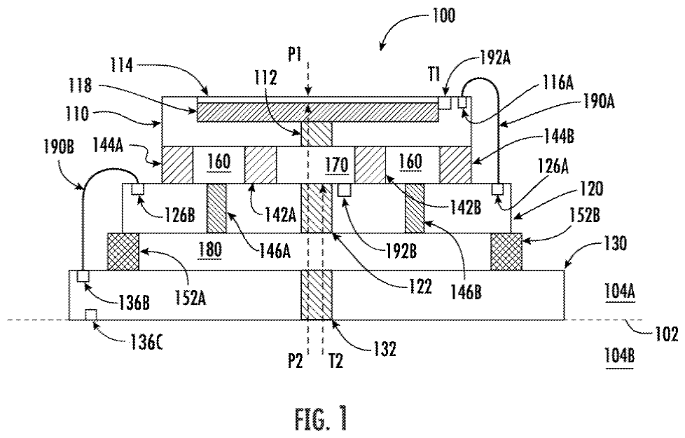

FIG. 1 illustrates a cross-section view of an example block diagram of an ultra-compact differential pressure sensor in accordance with one or more embodiments of the present disclosure. The ultra-compact differential pressure sensor 100 includes a differential pressure sensor 110 stacked on top of an ASIC 120 stacked on top of a substrate 130. The substrate 130 may be comprised of a ceramic, an organic, a PCB, or the like. The differential pressure sensor 110, ASIC 120, and/or substrate 130 may be electrically coupled through a plurality of bonding wires 190 or the like. For example, a first bonding wire 190A may electrically couple a terminal 116A of the differential pressure sensor 126A and a second bonding wire 190B may electrically couple a second terminal 126B of the ASIC 120 with a first terminal 136B of the substrate 130. The terminals may be, for example, bonding pads, bonding fingers, or the like. It will be appreciated that there may be a plurality of terminals on each of the differential pressure sensor 110, ASIC 120, and/or substrate 130 and these each of the terminals may be electrically coupled to one or more other terminals. There may also be one or more terminals 136C on the bottom of the substrate that may be used to electrically couple the ultra-compact differential pressure sensor with circuitry of a system and/or device.

In various embodiments, the differential pressure sensor 110 may be a MEMS differential pressure sensor. The differential pressure sensor 110 may include a sensing membrane 114 or another sensing element. The sensing membrane 114 of the differential pressure sensor 110 may be exposed to a first environment 104A on a first side (e.g., the top of the differential pressure sensor 110 as illustrated in FIG. 1) of the differential pressure sensor 110 and also exposed to a second environment 104B on a second side (e.g., the bottom of the differential pressure sensor 110 as illustrated in FIG. 1). The first environment 104A and the second environment 104B are separated from each other, with the first environment 104A having a first pressure P1 and a first temperature T1 and the second environment 104B having a second pressure P2 and a second temperature T2. It will be appreciated that the separation between the first environment 104A and the second environment 104B along line 102 illustrates a form of separation between the first environment 104A and second environment 104B. Exposure to the second environment 104B may be via a cavity 118 on a second side of the sensing membrane 114. The cavity 118 may be, for example, formed by the sensing membrane 114 and an interior portion of the differential pressure sensor 110, which may include a hard stopper. The second side of the differential pressure sensor 110 includes a differential pressure sensor channel 112 that connects the sensing membrane 114 to the second environment. The differential pressure sensor 110 may generate an electrical signal with a transducer based on the difference between the pressure of the first environment applied to the first side of the sensing membrane 114 and the pressure of the second environment applied to the second side of the sensing membrane 114. The transducer converts the differential pressure sensed by the sensing membrane 114 into an electrical signal that may vary with respect to the differential pressure. The electrical signal generated by the transducer may then be transmitted from the differential pressure sensor 110. It will be appreciated that the circuitry of the differential pressure sensor 110 as well as other components of the differential pressure sensor 110 and ASIC 120 are not illustrated in FIG. 1. It will also be appreciated that while the sensing membrane 114 is illustrated as being within the differential pressure sensor 110, the sensing membrane 114 will be exposed to a first environment on the first side of the differential pressure sensor 110, which may be by being located at or near the surface of the differential pressure sensor 110 or via one or more channels.

Between the differential pressure sensor 110 and the ASIC 120 are two rings: an inner ring 142 and an outer ring 144. The two rings 142, 144, along with the differential pressure sensor 110 and the ASIC 120, create an isolation region 160. In various embodiments, the two rings 142, 144 may be of the same material, such as dry resist film. For example, the dry resist film may be a polymer that may be laminated onto the differential pressure sensor 110 and/or the ASIC 120. It will be appreciated that the two rings 142, 144 may be applied in one or more patterns between the differential pressure sensor 110 and the ASIC 120 and, thus, do not have to be circular. In various embodiments, it will be appreciated that the two rings 142, 144 having a pattern may also include the locations of the differential pressure sensor channel 112, ASIC channel 122, substrate channel 132, isolation region 160, first opening 170, and/or one or more additional channels 146 may shift. For example, the differential pressure sensor channel 112, ASIC channel 122, and substrate channel 132 may be off-center with respect to the center of the ultra-compact differential pressure sensor 100.

The isolation region 160 provides for improved separation between the first environment and the second environment. In various embodiments, the isolation region 160 may be unfilled or may be filled with a substance. For example, the isolation region 160 may be filled with a glue. The rings 142A, 142B and isolation region 160 may also provide for improved relief of stresses the ultra-compact differential pressure sensor 100 may otherwise be subjected to, which may minimize the amount of stress(es) that are transferred to the sensing membrane 114. The reduction in transfer of such stress(es) provides for improved measurements by reducing or removing error.

In various embodiments, the isolation region 160 may be connected to the second environment 104B via one or more additional channels 146, such as a first ASIC isolation channel 146A, a second ASIC isolation channel 146B, etc.

Connecting the ASIC 120 and the substrate 130 is an adhesive layer 152. FIG. 1 is a cross-section view that illustrates a first adhesive layer portion 152A and a second adhesive layer portion 152B. It will be appreciated, particularly in view of FIG. 3, that the adhesive layer 152 may be one layer. The adhesive layer 152 may be patterned into one or more shapes. The shapes may depend on the electrical circuitry of the ASIC and/or substrate, including allowing for connections between circuitry of or on the ASIC 120 and/or substrate 130. In various embodiments the adhesive layer 152 may be a B-stage glue as further described herein.

A plurality of channels provide the second side of the differential pressure sensor 110 to the second environment. While not illustrated as separated, it will be appreciated that the first environment is different from the second environment. A differential pressure sensor channel 112 in the differential pressure sensor 110 connects the sensing membrane 114 to a first opening 170 between the differential pressure sensor 110 and the ASIC 120. The ASIC 120 includes an ASIC channel 122 that connects and exposes the first opening 170 to the second opening 180. The second opening 180 is the space between the ASIC and the substrate that is exposed to the second environment through a substrate channel 132 that runs through the substrate 130. The ASIC channel 122 and the substrate channel 132 may be referred to as through holes.

In various embodiments, the differential pressure sensor channel 112, the ASIC channel 122, and the substrate channel 132 may be aligned such that each of these channels have a shared axis. Alternatively, various embodiments may have these channels arranged so that they do not share an axis. For example, one or more of the channels may be offset in one or more directions or at one or more angles.

In various embodiments, the first environment may be atmospheric pressure and the second environment may be different from atmospheric pressure, or vice versa. For example, the second environment may be a liquid or a gas in an enclosed container and/or enclosed environment. The connections of the inner ring 142 and outer ring 144 between the differential pressure sensor 110 and the ASIC 120 and the connection of the adhesive layer 152 between the ASIC 120 and the substrate 130 may isolate the first environment from the second environment. Such isolation of environments may include water-tight seals or gas-tight seals depending on these environments.

In various embodiments, the ultra-compact differential pressure sensor include a plurality of temperature sensors. For example, a first temperature sensor 192A exposed to a first environment may determine the temperature of the first environment and a second temperature sensor 192B exposed to the second environment may determine the temperature of the second environment. A temperature sensor 192 of the ultra-compact differential pressure sensor may generate one or more signals associated with these temperatures, which may be referred to as temperature signals. For example, a first temperature signal may be associated with the temperature of the first environment, a second temperature signal may be associated with the second environment, and a third temperature signal may be associated with a difference in temperature between the first environment and the second environment (i.e., a differential temperature). It will be appreciated that while the first temperature sensor 192A is illustrated in pressure sensor 110 exposed to the first environment and the second temperature sensor 192B is illustrated in ASIC 120 the locations of the first temperature sensor 192A and the second temperature sensor 192B may be located in other portions or components of the ultra-compact differential pressure sensor 100. For example, the first pressure sensor 192A and the second pressure sensor 192B may both be located in the differential pressure sensor 110 so that each is exposed to its respective environment. Additionally, the temperature sensors 192 may be electrically coupled to one or more terminals. For example, the first temperature sensor 192A may be electrically coupled to terminal 116A and/or the second temperature sensor 192B may be electrically coupled to terminal 126A. Alternatively or additionally, there may be one or more electrical connections coupling the one or more temperature sensors 192 to the ASIC 120. A temperature signal may be transmitted from the ultra-compact differential pressure sensor 100 in addition to the electrical signal based on the differential pressure.

In various embodiments, the first temperature sensor 192A and the second temperature sensor 192B may each transmit a signal based on the respective temperature measurements to the ASIC 120. The first temperature sensor 192A may be located in the differential pressure sensor 110 to measure temperature T1 of the first environment 104A, such as on the surface of the differential pressure sensor 110. The second temperature sensor 192B may be in the ASIC 120 such that it is exposed to the second environment 104B and may measure temperature T2. The ASIC 120 may determine a difference in temperature based on the respective signals from the first temperature sensor 192A and the second temperature sensor 192B, and the ASIC 120 may generate the differential temperature. In various embodiments, the ultra-compact differential pressure sensor 100 may transmit a plurality of signals based on the pressures temperatures from the two environments, including a differential pressure, a first temperature, a second temperature, and/or a differential pressure.

The ASIC 120 may also determine one or more compensation factors. For example, a compensation factor may be based on a temperature or a temperature differential. The compensation factor may be based on a thermal effect (e.g., expansion of one or more portions the differential pressure sensor 110) that may impact a measurement. The ASIC 120 may adjust a measurement based on the compensation factor before and/or after generating a pressure and/or temperature signal. Alternatively or additionally, the ASIC 120 may generate a compensation signal based on the compensation factor that may be transmitted.

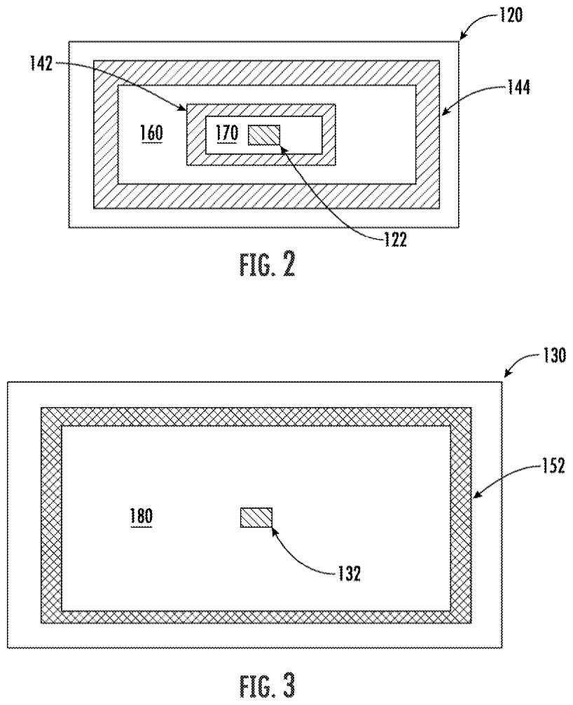

FIG. 2 illustrates a top down view of an example block diagram of a first portion of an ultra-compact differential pressure sensor in accordance with one or more embodiments of the present disclosure. The first portion of the ultra-compact differential pressure sensor 100 is illustrating a first side (e.g., top) of the ASIC 120 with the differential pressure sensor 110 omitted. The first side of the AISC 120 illustrated has the inner ring 142 and outer ring 144 applied to it to create the isolation region 160. The inner ring 142 is a first ring that surrounds the channel 122. When the differential pressure sensor 110 is attached to the ASIC 120 with the inner ring 142 and outer ring 144, the inner ring 142 with the differential pressure sensor 110 and the ASIC 120 creates a first opening 170. The first opening 170 is connected to the second environment and will allow for the second pressure from the second environment to be transmitted to a channel 112 the differential pressure device 110.

While the inner ring 142 and outer ring 144 are illustrated in ring patterns, it will be appreciated that alternatively patterns may be used for these two rings 142, 144 that will also create an isolation region 160 and first opening 170. For example, alternative snaking patterns for the outer ring 144 may be used to allow for a plurality of electrical contacts on the ASIC 120 to be exposed and connected to electrical connections (e.g., wire bonds).

FIG. 3 illustrates a top down view of an example block diagram of a second portion of an ultra-compact differential pressure sensor in accordance with one or more embodiments of the present disclosure. The second portion of the ultra-compact differential pressure sensor 100 is illustrating the substrate 130 and the adhesive layer 152 with the differential pressure sensor 110 and ASIC 120 omitted. The adhesive layer 152 may be deposited on the substrate 130 in a ring shape as illustrated. Alternatively or additionally, one or more deposition layers of adhesive layer 152 may be in other shapes. Inside the layer of adhesive layer 152 there is a second opening 180 and the substrate channel 132. The adhesive layer 152 may be glue that may be dispensed in a desired pattern. For example, the adhesive layer 152 may be a B-stage glue.

In embodiments with an adhesive layer 152 of a B-stage glue, the dispensing of the B-stage glue may be in a pattern. The B-stage glue may then be subjected to an ultraviolet (UV) light, such as a flash of UV light. Subjecting the B-stage glue to the UV light may polymerize the B-stage glue into the desired pattern causing it to hold the shape of the pattern and not to bleed or otherwise spread. The B-stage glue may later be cured after attaching the ASIC 120 to the substrate 130 to connect the ASIC 120 to the substrate 130 with an appropriate seal.

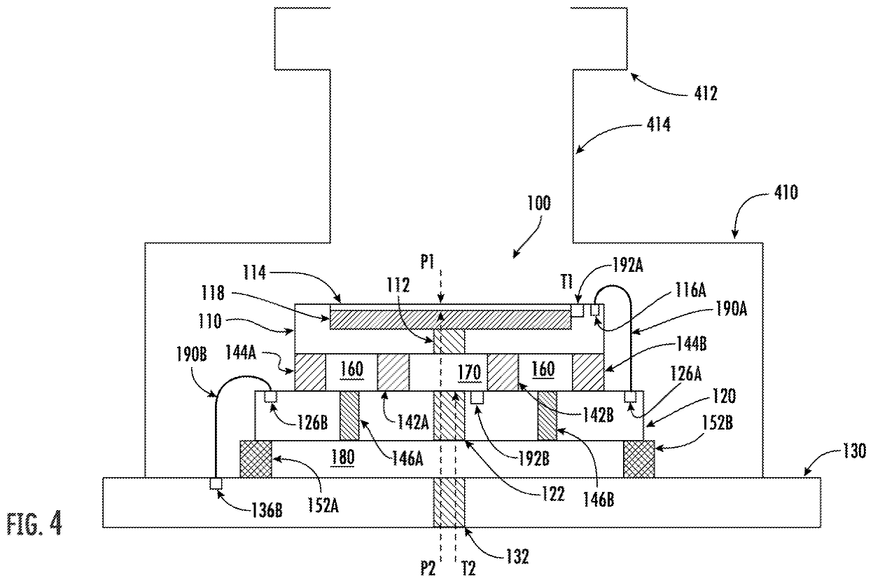

FIG. 4 illustrates a cross-section view an example block diagram of an ultra-compact differential pressure sensor including a structure in accordance with one or more embodiments of the present disclosure. FIG. 4 illustrates the ultra-compact differential pressure sensor 100 within a structure 400. The structure 400 may be connected to the substrate 130 and enclose the ultra-compact differential pressure sensor 100. This connection may be with an adhesive layer that provides a water-tight seal and/or a gas-tight seal. Within the structure 400 the electrical connections among the differential pressure sensor 110, the ASIC 120, and the substrate 130 may be through, for example, bonded wires (e.g., Au wire, Cu wires, and the like).

In various embodiments, the structure 400 may include a lip 412 that is sized based on a connection to one or more systems and/or devices the ultra-compact differential pressure sensor 100 will be used in. In various embodiments, the structure 400 may be a metal cap, metal lid, or the like. The lip 412 may be a part of the metal cap or metal lid that defines an upper cavity of the structure 400. The structure 400 may include an portion 414 sized for one or more gaskets (e.g., o-ring) allowing for connecting or integrating the ultra-compact differential pressure sensor 100 to a larger system, apparatus, or device. The portion 414 may be a port. While not depicted, the structure 400 may include multiple ports that may be connected to the first environment. Thus exposure of the ultra-compact differential pressure sensor 100 to the first environment may be via the structure 400. Additionally, the structure 400 may be shaped to provide or control what or how the first environment is measured, such as by limiting an amount of the first environment that may allowed to contact the differential pressure sensor 110.

In various embodiments a second structure similar to the first structure 400 may connected to the second side (e.g., the bottom as illustrated) of the substrate 130.

Additionally, the structure 400 may include potting gel. The potting gel may separate the ultra-compact differential pressure sensor 100 from the first environment while allowing for the pressure exerted by the first environment to be applied to and measured by the ultra-compact differential pressure sensor 100. For example, potting gel may be used to separate the ultra-compact differential pressure sensor 100 from a harsh environment containing materials that may damage the stacked differential pressure sensor 100, such as caustic materials. Additionally or alternatively, the potting gel may be used as a barrier that prevents dust and/or oil from being received by the differential pressure sensor 110. The potting gel may further act as an insulator that may control or mitigate changes in temperature or humidity that may otherwise impact the pressure measured by the differential pressure sensor 110. Thus, embodiments with potting gel may serve to protect the differential pressure sensor 110, the ASIC 120, bonding wires, terminals (e.g., 116, 126, 136), and portions of the substrate 130 under the potting gel.

It should be readily appreciated that the embodiments of the systems and apparatuses, described herein may be configured in various additional and alternative manners in addition to those expressly described herein.

### Exemplary Methods

FIG. 5 illustrates an example block diagram of a first flow chart of operations for manufacturing an exemplary ultra-compact differential pressure sensor in accordance with one or more embodiments of the present disclosure. While FIG. 5 illustrates a plurality of operations in an order, it will be appreciated that one or more operations may be omitted and/or iterated.

At operation 502, a substrate channel 132 is prepared in the substrate 130. For example, a punch may be used to create a substrate channel 132.

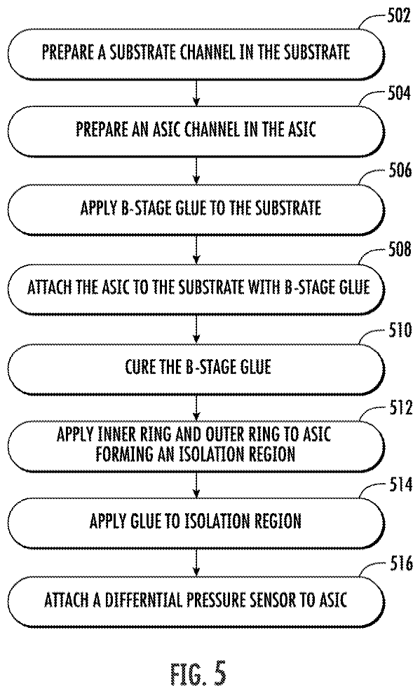

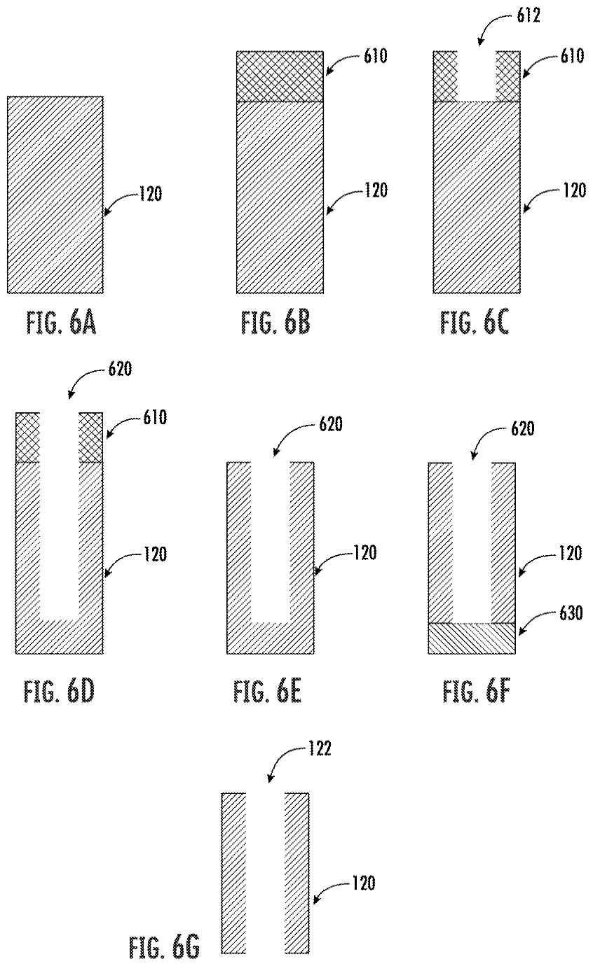

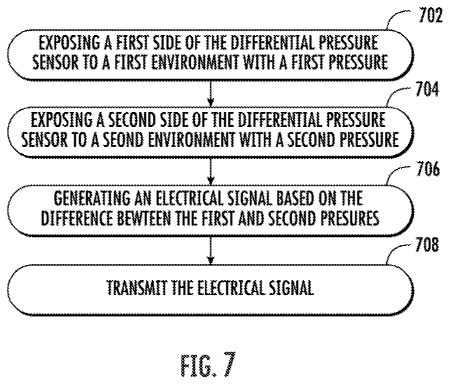

At operation 504, an ASIC channel 122 is prepared in the ASIC 120. This operation is further described herein with respect to FIGS. 6A-6F.

At operation 506, a B-stage glue is applied to the substrate 130. The B-stage glue 152 is applied to a first side or top side of the substrate 130 by dispensing the B-stage glue 152 into a pattern. The B-stage glue 152, once dispensed, may be exposed to a first light (e.g., UV light flash) that causes to the B-stage glue 152 to set. Once set, the B-stage glue 152 may hold the pattern without running or bleeding.

At operation 508, the ASIC 120 is attached to the substrate 130 with the B-stage glue 152. The attachment may include aligning the ASIC channel 122 of the ASIC 120 with the substrate channel 132 of the substrate 130. Alternatively, the attachment may include placing the ASIC 120 such that there is an offset between the ASIC channel 122 of the ASIC 120 and the substrate channel 132 of the substrate 130. As the ASIC 120 is attached to the substrate 130 via the B-stage glue 152, a second opening 180 is formed.

At operation 510, the B-stage glue is cured. The curing of the B-stage glue 152 fixedly attaches the ASIC 120 to the substrate 130.

At operation 512, inner ring 142 and outer ring 144 are applied to the ASIC 120 to form an isolation region 160. The inner ring 142 and outer ring 144 of a film may be applied in desired patterns to the top side of the ASIC 120. The patterns include the outer ring 144 surrounding the inner ring 142 to create an isolation region 160 between the inner ring 142 and the outer ring 144. The film may be a dry resist film.

At operation 514, glue is applied to the isolation region. The application of glue may fill all or a portion of the isolation region. The inner ring 142 and outer ring 144 may bound the isolation region 160 to limit the spread of the glue as it is applied so that the glue does not spread or bleed outside of the isolation region. The glue may be a soft glue that provides mechanical and thermal decoupling or insulation.

At operation 516, the differential pressure sensor 110 is attached to the ASIC 120. A bottom side or back side of the differential pressure sensor 110 is attached to the top side of the ASIC 120 by the inner ring 142 and the outer ring 144. In attaching the differential pressure sensor 110, the differential pressure channel 112 of the differential pressure sensor 110 may be aligned with the ASIC channel 122 of the ASIC 120. Alternatively, the attachment may include placing the differential pressure sensor 110 such that there is an offset between the differential pressure channel 112 of the differential pressure sensor 110 and the ASIC channel 122 of the ASIC 120.

FIGS. 6A-6G illustrate example diagrams for operations to prepare a channel in an ASIC. Preparing an ASIC channel 120 may include one or more operations, such as: masking an ASIC 120, etching the resist for the location of the ASIC channel 122, etching the substrate of the ASIC 120 to create a partial channel, removing the resist, thinning the ASIC 120 to remove a bottom portion and create an ASIC channel 122.

FIG. 6A illustrates a cross-section of a first portion of an ASIC 120 where a channel 122 will be prepared. This first portion of the ASIC 120 may include a substrate of the ASIC 120 and/or circuitry of the ASIC 120.

FIG. 6B illustrates a cross-section of the first portion of the ASIC 120 with a mask 610 applied over the first portion of the ASIC 120. While only the first portion of the ASIC 120 is illustrated, it will be appreciated that the mask 610 may cover the entirety the first side of the ASIC 120. This may include masking over additional components and/or circuitry locating in or on the first side of the ASIC 120. The mask may, for example, be a resist.

FIG. 6C illustrates a cross-section of a first portion of an ASIC 120 with a resist etch performed to create one or more apertures 612 in the resist 610. The resist etch may, for example, be a dielectric etch.

FIG. 6D illustrates a cross-section of a first portion of an ASIC 120 with a dielectric etch performed to create a partial channel in the ASIC 120 at the locations of the apertures 612 in the resist 610. The etch may, for example, be a deep silicon etch.

FIG. 6E illustrates a cross-section of a first portion of an ASIC 120 with the mask 610 removed from the ASIC 120 and the ASIC 120 having the partial channel 620.

FIG. 6F illustrates a cross-section of a first portion of an ASIC 120 with a bottom portion 630 at one end of the partial channel 620. The bottom portion 630 may be a wafer or panel portion to be subjected to thinning. For example, wafer thinning will remove the bottom portion 630.

FIG. 6G illustrates a cross-section of a first portion of an ASIC 120 with the channel 122.

Various embodiments may also include additional operations to manufacture the ultra-compact stacked differential pressure sensor 100. A plurality of electrical connections (e.g., wire bonds, etc.) may be formed to connect circuitry of the ultra-compact stacked differential pressure sensor 100. For example, wire bonds may be made to connect the output of the transducer of the differential pressure sensor 110 to the ASIC 120 and/or one or more termination points on the substrates. Similarly, wire bonds may be made to connect one or more termination points of the ASIC 120 to one or more termination points on the substrate 130.

Additionally, a structure 410 may be connected to the substrate 130. This connection may be with an adhesive, such as a glue. In various embodiments the structure 410 may be filled partially or fully with a potting gel. Similarly, a second structure may be connected to a second side of the substrate 130 so that there is a first structure 410 on the first side and a second structure on the second side.

Various embodiments may include the preparation of a plurality of ultra-compact stacked differential pressure sensors 100 at the same time. For example, a panel or wafer of 100 ultra-compact stacked differential pressure sensors 100 may be prepared at the same time. The preparation of the plurality of ultra-compact stacked differential pressure sensors 100 may include performing iterations of operations described herein. Such iterations may be performed in series or in parallel as each ultra-compact stacked differential pressure sensors 100 of the plurality of ultra-compact stacked differential pressure sensors 100 is prepared on the panel or wafer. Once a panel or wafer of ultra-compact stacked differential pressure sensors 100 is prepared, individual ultra-compact stacked differential pressure sensors 100 may be separated from the panel or wafer, such as with one or more singulation operations.

FIG. 7 illustrates an example block diagram of a flow chart of operations for operating an exemplary ultra-compact differential pressure sensor in accordance with one or more embodiments of the present disclosure.

At operation 702, a first side of the differential pressure sensor 110 is exposed to a first environment with a first pressure. The first pressure is applied to a first side of the sensing membrane 114.

At operation 704, a second side of the differential pressure sensor 110 is exposed to a second environment with a second pressure. The second environment is exposed to the sensing membrane 114 of the differential pressure sensor 110 via the substrate channel 132, ASIC channel 122, and the differential pressure sensor channel 112.

At operation 706, an electrical signal is generated based on the differences between the first and second pressures applied to the sensing membrane 114. For example, the pressures may cause a deflection and/or displacement in a portion or all of a sensing membrane 114, and this may change the electrical properties of the transducer of the differential pressure sensor 110. The change in electrical properties may be used to generate an electrical signal.

At operation 708, the electrical signal is transmitted. The electrical signal generated based on the differential pressure may be transmitted from the transducer of the differential pressure sensor 110. The electrical signal may be transmitted to the ASIC 120 and/or substrate 130 via one or more electrical connections made to the differential pressure sensor 110.

It should be readily appreciated that the embodiments of methods described herein may be configured in various additional and alternative manners in addition to those expressly described herein, including iterating one or more operations described herein and/or omitting one or more operations described herein.

### CONCLUSION

Operations and/or functions of the present disclosure have been described herein, such as in flowcharts. While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While this detailed description has set forth some embodiments of the present invention, the appended claims cover other embodiments of the present invention which differ from the described embodiments according to various modifications and improvements.

Within the appended claims, unless the specific term “means for” or “step for” is used within a given claim, it is not intended that the claim be interpreted under 35 U.S.C. § 112, paragraph 6.

1. An apparatus comprising:
a differential pressure sensor with a first side of the differential pressure sensor, a second side of the differential pressure sensor, and a differential pressure sensor channel, wherein the differential pressure sensor channel includes an aperture on the second side;
an ASIC with an ASIC channel, wherein the ASIC channel that connects a first side of the ASIC with the second side of the ASIC;
a substrate with a first side of the substrate, a second side of the substrate, and a substrate channel that connects the first side of the substrate with the second side of the substrate;
wherein the differential pressure sensor is connected to the ASIC by a first inner ring and a second outer ring, wherein the first inner ring surrounds the second outer ring to form an isolation region between the first inner ring and the second outer ring; and
wherein the ASIC is connected to the substrate by a first glue.

2. The apparatus of claim 1, wherein the differential pressure sensor includes a sensing membrane to sense a pressure difference between a first pressure on a first side of the differential pressure sensor and a second pressure from a second side of the differential pressure sensor.

3. The apparatus of claim 2, wherein the second pressure is transmitted to the sensing membrane via the differential pressure sensor channel, the ASIC channel, and the substrate channel.

4. The apparatus of claim 1, wherein the isolation region is at least partially filled with a second glue.

5. The apparatus of claim 1 further comprising:
a structure attached to the substrate, wherein the differential pressure sensor and the ASIC are encompassed by the structure.

6. The apparatus of claim 5, wherein the structure is at least partially filled with a gel to cover the differential pressure sensor and the ASIC.

7. The apparatus of claim 1, wherein the differential pressure sensor channel, the ASIC channel, and the substrate channel are aligned with a common axis.

8. A method of manufacturing an ultra-compact differential pressure sensor comprising:
creating a substrate channel in a substrate;
creating a ASIC channel in an ASIC;
attaching the ASIC to the substrate with a first glue;
applying a first ring and a second ring to the ASIC forming an isolation region between the first ring and the second ring;
attaching the differential pressure sensor to the ASIC with the first ring and the second ring.

9. The method of manufacturing an ultra-compact differential pressure sensor of claim 8, wherein the differential pressure sensor includes a sensing membrane to sense a pressure difference between a first pressure on a first side of the differential pressure sensor and a second pressure from a second side of the differential pressure sensor.

10. The method of manufacturing an ultra-compact differential pressure sensor of claim 9, wherein the second pressure is transmitted to the sensing membrane via a differential pressure sensor channel, the ASIC channel, and the substrate channel.

11. The method of manufacturing an ultra-compact differential pressure sensor of claim 8 further comprising:
filling, prior to attaching the differential pressure sensor to the ASIC with the first ring and the second ring, the isolation region with a second glue.

12. The method of manufacturing an ultra-compact differential pressure sensor of claim 8 further comprising:
attaching a structure to the substrate to encompass the differential pressure sensor and the ASIC.

13. The method of manufacturing an ultra-compact differential pressure sensor of claim 12 further comprising:
filling the structure at least partially with a potting gel, wherein the potting gel covers the differential pressure sensor and the ASIC.

14. The method of manufacturing an ultra-compact differential pressure sensor of claim 8, wherein a differential pressure sensor channel, the ASIC channel, and a substrate channel are aligned with a common axis.

15. A method of using an ultra-compact differential pressure sensor comprising:
providing the ultra-compact differential pressure sensor comprising:
a differential pressure sensor with a first side of the differential pressure sensor, a second side of the differential pressure sensor, and a differential pressure sensor channel, wherein the differential pressure sensor channel includes an aperture on the second side;
an ASIC with an ASIC channel, wherein the ASIC channel that connects a first side of the ASIC with the second side of the ASIC;
a substrate with a first side of the substrate, a second side of the substrate, and a substrate channel that connects the first side of the substrate with the second side of the substrate;
wherein the differential pressure sensor is connected to the ASIC by a first inner ring and a second outer ring, wherein the first inner ring surrounds the second outer ring to form an isolation region between the first inner ring and the second outer ring;
wherein the ASIC is connected to the substrate by a first glue;
sensing a difference between a first pressure and a second pressure with a sensing membrane of the differential pressure sensor; and
generating an electrical signal based on the difference between the first pressure and the second pressure sensed.

16. The method of using an ultra-compact differential pressure sensor of claim 15 further comprising:
transmitting, prior to sensing the difference between the first pressure and the second pressure, the second pressure to the sensing membrane via the differential pressure sensor channel, the ASIC channel, and the substrate channel.

17. The method of using an ultra-compact differential pressure sensor of claim 15, wherein the isolation region is at least partially filled with a second glue.

18. The method of using an ultra-compact differential pressure sensor of claim 15, wherein the ultra-compact differential pressure sensor further comprises:
a structure attached to the substrate, wherein the differential pressure sensor and the ASIC are encompassed by the structure.

19. The method of using an ultra-compact differential pressure sensor of claim 18, wherein the structure is at least partially filled with a gel to cover the differential pressure sensor and the ASIC.

20. The method of using an ultra-compact differential pressure sensor of claim 15, wherein the differential pressure sensor channel, the ASIC channel, and the substrate channel are aligned with a common axis.
